(19) United States
(12) Patent Application Publication
(10) Pub. No.: US 2008/0151698 A1
(43) Pub. Date: Jun. 26, 2008

(54) ON-DEMAND DISPLAY DEVICE FOR A TIMEPIECE

(76) Inventors: Ramon GIL, Bellevue (CH); Jean-Claude QUENET, Chambrelien (CH)

Correspondence Address: OSTROLENK FABER GERB & SOFFEN, 1180 AVENUE OF THE AMERICAS, NEW YORK, NY, 100368403, US

(21) Appl. No.: 11/958,947

(22) Filed: Dec. 18, 2007

(30) Foreign Application Priority Data
Dec. 23, 2006 (CH) 02094/06

(51) Int. Cl. G04B 19/06; G04B 19/24; G04B 19/26

(52) U.S. Cl. 368/18; 368/76; 368/28

(57) ABSTRACT

The display device, which is arranged to display the minutes and hours, comprises two cams driven separately from the cannon pinion and the hour wheel of a horological movement, a lever held in the idle position by a spring being actuated manually on demand by means of a push button placed outside the corresponding timepiece, so as to make a rack turn on its axis until the moment when a finger of each rack abuts on its respective cam, the rack during its rotation driving a pinion carrying hands indicating the minutes and the hour.

### REFERENCE TO RELATED APPLICATIONS

This application claims the benefit of the filing date of French Patent Application No. 02094/06, filed Dec. 23, 2006, the disclosure of which is hereby incorporated by reference.

### SUMMARY OF THE INVENTION

The object of the invention is a display device for a timepiece, driven by a base wheel of a horological movement, controlling the display of a time indication member. Base wheel of the horological movement means any wheel intended to control, by means of the device, a hand, a disc or any time indication mechanism, in particular any wheel intended to control the display of the seconds, the minutes, the hours, the date, the day, the week, the month, the phases of the moon, the year or years, or any indication relating to the functioning of the timepiece, such as for example the remaining running time.

The on-demand display device is characterised in that the base wheel drives a cam, a lever held in the standby position by a spring being actuated manually on demand by means of a push button placed outside the timepiece, so as to make a rack turn on its axis until the moment when a finger of the rack comes to abut on the cam, the rack in its rotation driving a pinion carrying the member indicating the time or the functioning of the timepiece, the cam having a configuration corresponding to the series of values to be displayed.

According to a preferred embodiment, the base wheel is the cannon pinion controlling the display of the minutes and the device is driven by a second base wheel of the timepiece, which is the hour wheel, which drives a second cam, a lever, also maintained in the standby position by a second spring, being actuated manually on demand by means of the same push button systematically controlling the two levers so as to make a second rack turn on its axis, until the time when a finger of the second rack abuts on the cam, the second rack, during its rotation, driving a pinion carrying a time indication member, the cams having a configuration corresponding to the series of minutes or respectively hours to be displayed.

The base wheel can transmit the rotation movement to the cam by means of a setting wheel and a wheel secured to the cam, the base wheels travelling one turn in one hour or respectively in twelve hours.

The time indication members can be hands, discs or any device arranged to indicate the seconds, the minutes, the hours, the date, the day, the week, the month, the phases of the moon, the year, etc, or data relating to the functioning of the timepiece.

The pinions driven by the racks are concentric and the racks placed on each side of the concentric axes of said pinions each carrying a hand.

The two hands of the timepiece can be placed at midday when the levers controlling the racks are in the standby position.

The drawing depicts, by way of example, an embodiment of the on-demand display device for a timepiece.

### BRIEF DESCRIPTION OF DRAWINGS

FIG. 1 is a view of the timepiece showing the two minute and hour hands in position at twelve o'clock before the push button is actuated,

FIG. 2 is a plan view of the on-demand display device intended to display, on demand, the minutes and hours as soon as the push button is actuated, and

FIG. 3 is a perspective view showing the functioning of the racks placed at different heights, so as to be able to drive the superimposed pinions carrying the hands.

### DESCRIPTION OF PREFERRED EMBODIMENTS OF THE INVENTION

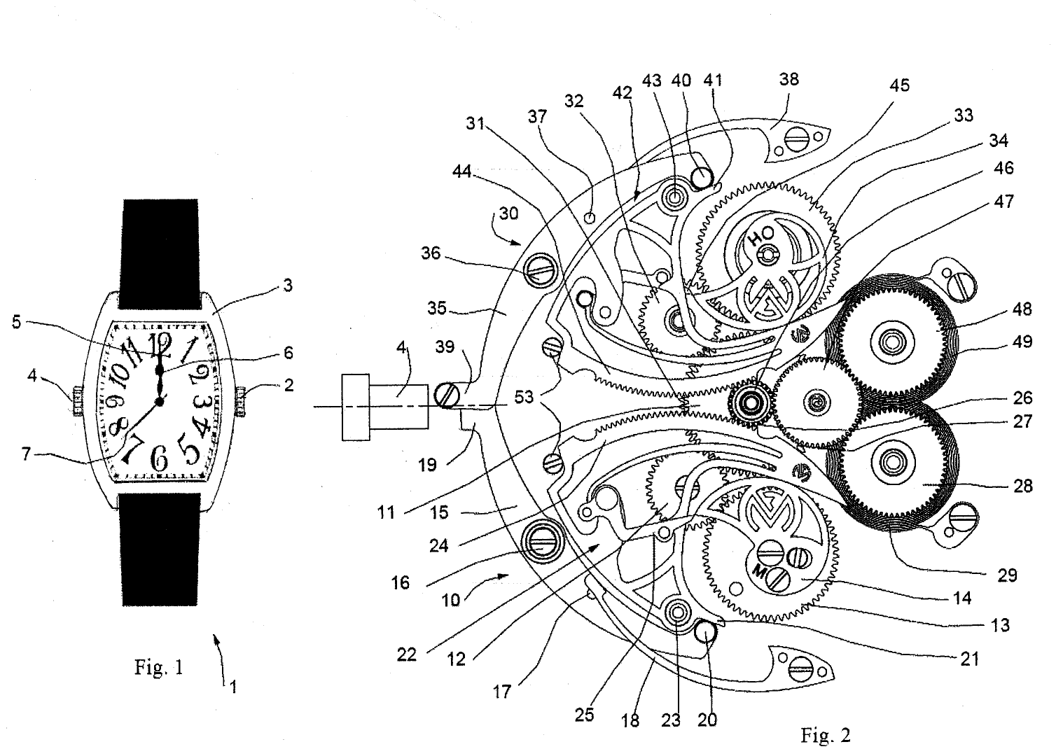

The timepiece shown in FIG. 1 comprises a winder situated to the right of the case and a push button intended to control the display on demand of the minutes and hour placed to the left of the case of FIG. 1.

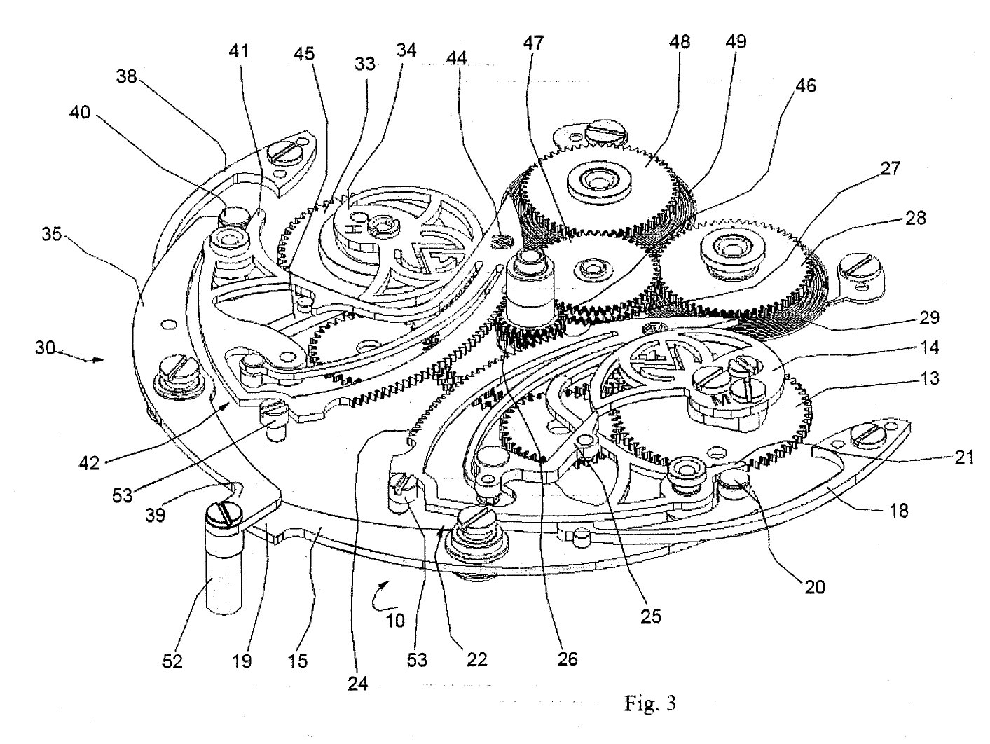

As shown in FIGS. 1 and 2 the hands indicating the minutes and the hour are placed at twelve o'clock when the push button situated to the left of the case is not actuated. As soon as the push button is pressed, the device is actuated and the minutes and hour are indicated as explained below in relation to FIGS. 2 and 3.

On the left-hand parts of FIGS. 2 and 3 the part of the display device that indicates the minutes is shown, while the part of the display device, that indicates the hours is placed to the right of FIGS. 2 and 3.

Looking now at the left-hand part of the device of the timepiece displaying minutes on demand, a base wheel 1, referred to as a cannon pinion can be seen, it being understood that it travels one turn in one hour and is intended to control the display of the minutes. The base wheel or cannon pinion 1 transmits the movement of the timepiece to a setting wheel 2 that drives a wheel 3 secured to a cam 3, the wheel 3 and the cam 3 meshing so as to perform one turn in one hour.

A lever 5 is held in the standby position by a spring 6 in contact with a push button 7 actuated manually on demand from outside the timepiece, the push button 7 coming to act indirectly on the lever 5 which, when it is pressed, turns the rack 4 on its axis until the moment when a finger 4 secured to the rack comes to abut against the cam 3. During this rotation movement of the rack 4, the pinion 1 which carries the minute hand is driven until the moment when it indicates a position corresponding to the running of the timepiece. As soon as the pressure effected on the push button 7 is interrupted, the lever 5 rises again and the hand indicating the minutes returns to twelve o'clock.

Looking now at the right-hand part of the drawing, it can be seen that the lever 5 is in contact with a lever 10 that will control the indication of the hour hand as indicated below. The contact established between levers 5 and 10 is made by a pin placed at the end of the lever 10, a pin that will be in contact with the push button 7. It will thus be remarked that, when the push button 7 is actuated, it will act on the lever 5 by means of the pin of the lever 10 and thus the two levers 5 and 10 will be actuated at the same time.

As for the left hand part of the device for indicating the time on demand, the hour wheel 1 transmits its movement to a wheel 9 by means of a setting wheel 8. The wheel 9 is secured to a cam 9 and the hour wheel 1, just as the wheel 9 secured to the cam 9 thus makes one turn in twelve hours.

A lever 10 held in the standby position by a spring 11 is actuated by the push button 7 at the same time as the lever 5. The display demand coming from outside the watch to the push button 7 acts on the lever 10, which makes the rack 12 turn on its axis, a finger 12 secured to the rack 12 coming at its end of travel to abut on the cam 9. During its action performed by the push button 7, the lever 10 rotates the rack 12, which meshes with the pinion 1 that carries the hour hand.

When the two fingers 4 and 12 of the racks intended to indicate the minutes and hours are in contact with their respective cam 3 and 9, the timepiece can thus indicate the time. As soon as the push button 7 is released, the hands return to twelve o'clock by virtue of the action of the springs 6 and 11, which return the levers 5 and 10 to their standby position.

As mentioned in the introduction, the device that has just been described is not limited to the indication of the minutes and hours in a timepiece. On the contrary, one or other of the left and right parts of this device can be used to indicate any display relating to time data. It can thus be used to indicate the seconds, the date, the day, the week, the month, the phases of the moon or the year or years. It can also be used to indicate, on demand, other displays such as the remaining running time of a timepiece or any indication relating to the functioning of the timepiece.

What is claimed is:

1. An on-demand display device for a timepiece driven by a base wheel of a horological movement controlling the display of a member indicating the time or the functioning of the timepiece, wherein the base wheel drives a cam, a lever held in the standby position by a spring being actuated manually on demand by means of a push button placed outside the timepiece, so as to turn a rack on its axis until the moment when a finger of the rack abuts against the cam, the rack in its rotation driving a pinion carrying the member indicating the time or the functioning of the timepiece, the cam having a configuration corresponding to the series of values to be displayed.

2. The device according to claim 1, wherein the base wheel is the cannon pinion controlling the display of the minutes and in that a second base wheel of the timepiece, which is the hour wheel, drives a second cam, a lever also held in the standby position by a spring being actuated manually on demand by means of the push button controlling simultaneously the two levers, so as to make a second rack turn on its axis until the moment when a finger of the second rack comes to abut against the cam, the rack driving in its rotation a pinion carrying a time indication member, the cams having a configuration corresponding to the series of minutes or respectively hours to be displayed.

3. The device according to claim 1, wherein the base wheel transmits the rotation movement to the cam by means of a setting wheel and a wheel secured to the cam, the base wheels travelling one turn in an hour and respectively in twelve hours.

4. The device according to claim 1, wherein the time indication members are hands, discs or any device arranged to indicate the seconds, the minutes, the hours, the date, the week, the month, the phases of the moon, the year, etc or data relating to the functioning of the timepiece.

5. The device according to claim 2, wherein the pinions are concentric and driven by the racks placed on each side of the concentric axes of said pinions and each carrying a hand.

6. The device according to claim 5, wherein the two hands of the timepiece are placed at midday when the levers are in the standby position.
